(19) United States
(12) Patent Application Publication
(10) Pub. No.: US 2025/0328933 A1
(43) Pub. Date: Oct. 23, 2025

(54) CARDS, DEVICES, SYSTEMS, ECOSYSTEMS, CHARITABLE APPLICATIONS, COLLECTOR APPLICATIONS AND METHODS OF PROCESSING CHARITABLE CONTRIBUTIONS

(71) Applicant: Dynamics Inc., Cheswick, PA (US)

(72) Inventors: Jeffrey D. Mullen, Glenshaw, PA (US); Jonathan L. Beaver, Bridgeville, PA (US); Bryan M. Froud, New Kensington, PA (US); Andrew Veter, Pittsburgh, PA (US)

(21) Appl. No.: 19/252,645

(22) Filed: Jun. 27, 2025

Related U.S. Application Data
(63) Continuation of application No. 13/855,103, filed on Apr. 2, 2013.
(60) Provisional application No. 61/619,182, filed on Apr. 2, 2012.

(51) Int. Cl. G06Q 30/0279

(52) U.S. Cl. CPC G06Q 30/0279

(57) ABSTRACT

An ecosystem provider may provide an ecosystem associating payment method cards and applications. The applications may provide features to a user. The features may include methods of contributing to charities and/or methods of obtaining collectible items by meeting performance metrics. The performance metrics may be related to the use of payment methods and/or payment method cards.

This application claims the benefit of U.S. patent application Ser. No. 13/855,103, titled “CARDS, DEVICES, SYSTEMS, ECOSYSTEMS, CHARITABLE APPLICATIONS, COLLECTOR APPLICATIONS AND METHODS OF PROCESSING CHARITABLE CONTRIBUTIONS,” filed Apr. 2, 2013, which claimed the benefit of U.S. Provisional Patent Application No. 61/619,182, titled “CARDS, DEVICES, SYSTEMS, ECOSYSTEMS, CHARITABLE APPLICATIONS, COLLECTOR APPLICATIONS AND METHODS OF PROCESSING CHARITABLE CONTRIBUTIONS,” filed Apr. 2, 2012 (Attorney Docket No. D/088 PROV), which are hereby incorporated by reference herein in their entirety.

### BACKGROUND OF THE INVENTION

This invention relates to magnetic cards, devices and payment systems.

### SUMMARY OF THE INVENTION

Systems and methods are provided for allowing a user to select an additional service to be performed in addition to the payment of goods with a payment card or other device (e.g., a mobile telephonic device, a tablet computer device, or another electronic device). A card, or other device, may include one or more buttons. A user may associate an additional service to a button of a card at any time. At the time of purchase, information indicative of the button the user selected may be passed to a point-of-sale system with a user's payment information. Such data may be, for example, communicated through a merchant acquirer's network to a processing facility.

The processing facility may, for example, authorize a payment transaction and forward the information indicative of the button a user selected and the identity of a user to a remote facility. Such a remote facility may, for example, forward at least some of such information, as well as additional information, to a third party service provider such that the third party service provider enacts the additional feature desired by the user.

Such an additional feature may include, for example, a game action in an online game by a game service provider, a check-in to a location by a check-in service provider, redeem a coupon or voucher by a third party coupon provider, earn loyalty points by a third party loyalty service, rate a transaction or location by a rating service, any combination of such features, and/or any additional feature.

Selection of a feature may be provided, for example, by a Graphical User Interface (GUI) provided on a computing device (e.g., a mobile telephonic device) as a software application for that device or via the internet or an intranet through a web browser. Such a selection may be provided with a non-powered card such that a single feature may be associated with a card for a period of time. Such a selection may be associated to an option (e.g., a button) on a powered card or other device (e.g., a mobile telephonic device) such that the user may associate different features with different options (e.g., different buttons).

Accordingly, for example, a user may receive a powered card, or other device, in the mail and use his/her web browser to associate different additional features to different buttons. The user may then utilize the card in a store and press a button in order to select that feature. A card, or other device, may download information (e.g., via a wireless communication such as a light or electromagnetic communication) such that the card, or other device, displays information next to an option indicative of the feature (e.g., “Redeem LivingSocial Voucher,” “Facebook Like”). Alternatively, no download may be provided and no additional information may be display may be provided such that a user's card, or other device, includes a generic descriptor (e.g., “credit” and “feature,” or “feature 1” and “feature 2,” or “debit” and “feature 1” and “feature 2”).

A remote facility may also receive additional information than just a user identifier and information indicative of the option selected by a user (or that the user made a payment). Such additional information may be, for example, the type of merchant (e.g., a retail merchant or a gas merchant), the location of a merchant (e.g., the zip code of a merchant), the type of transaction (e.g., online or in-store purchase), the name of the merchant (e.g., “Amazon. com,” or “Walmart”), the amount of the transaction (e.g., $10.25), and any other information. Such a remote facility may forward such information to a third party service provider in addition to information generated by the remote facility (e.g., a second user identifier such that different identifiers are used with the facility sending payment information and the third party service provider).

A feature/payment method ecosystem may be provided in which a development kit is available for third parties to develop applications for payment cards or other devices. A GUI may be provided where a user can select different third party applications to be associated with one or more user payment methods. The third party applications may need to be approved by an administrator before being accessible by a GUI.

Different categories of third party applications may be provided on the GUI (e.g., a coupon category, a check-in category, a games category, a financial management tools category). The development kit may provide the ability for a third party service provider to, for example, receive user identification numbers and other information (e.g., merchant name and location) and provide particular information back (e.g., within a period of time) to a remote facility.

Information received from a third party service provider may include, for example, information indicative that the user was properly identified and a service was performed (e.g., “check-in completed,” “information added to financial management service.”). Such information may be provided back to an issuing bank, processor, or other service provider such that the information may be displayed on a user's bill statement. Additional information may also be provided that may change the way a transaction is authorized or settled.

Additional information received from a third party may be utilized to change the way a transaction is authorized or settled. For example, a third party may provide a user with the ability to pre-purchase a voucher to a particular store (e.g., a particular barber in a particular zip code). A user may associate this third party service to a button on the user's card. A user may make a purchase at this barber multiple times during a year on the user's credit account. The user may, at one such purchase, press the button associated with the desire to use the third party service and redeem a voucher the user already purchased or acquired. Information indicative of the user's desire to utilize such a service may be communicated to a point-of-sale terminal via a communications device located on the card (e.g., a dynamic magnetic stripe communications device, an RFID antenna, an exposed IC chip (e.g., an EMV chip, or any other communications device). The transaction may be authorized using the user's payment account if, for example, the user has enough funds associated with that account (e.g., a credit or debit account).

The third party service provider may then determine the user had a pre-paid voucher for the transaction and may return to the card issuer, processor, or other party information indicative that the user's bill is to be adjusted by the amount of the voucher. Before, or after, settlement occurs a user's bill may show a statement credit in the amount of the voucher. A remote facility may perform such a data exchange as well as any associated value exchange. For example, the remote facility may, for a fee (e.g., a percentage of a transaction or a fixed fee), provide value from the third party service provider to the card issuer or processor (e.g., via an ACH or other type of monetary transaction).

Alternatively, for example, the remote facility may provide the desired value to the card issuer, processor, or other party and demand the associated value be paid to the remote facility by the third party service provider within a period of time (e.g., three days). Information provided by a third party service provider to a remote facility may include an identifier indicative of the third party service provider, an identifier indicative of the user, an identifier indicative of the type of service provided by the third party service provider, an identifier indicative of the transaction with which further action by the third party service provider is desired, an amount of a post-statement credit that is to be applied for a particular transaction, and amount of a post-settlement credit that is to be applied for a particular transaction, an amount of a pre-settlement credit that is to be applied for a particular transaction, an amount of a credit that is to be applied during an authorization, an additional fee that is supposed to be added to a statement for an additional service (e.g., a fee-based financial management tool service), and any other information desired by the third party service provider, processor, card issuer, remote facility, device provider, or any other entity (e.g., a card network).

Information indicative of a button press, or use of a card, that triggers a feature may be provided in a payment message utilized at authorization or at settlement. Furthermore, the service provider may return information in a period of time that permits actions to be performed pre-authorization or pre-settlement.

The payment actions may be determined, for example, via a user interaction with the card. Particularly, for example, a user may press a button on the card, from a group of buttons, that is associated with the third party feature. Such third party features may be unique from the features provided to the user via the third parties non-payment card or device services. Accordingly, a user may obtain the benefit of the whimsical and festive nature of a unique feature every time the user makes a payment.

Information indicative of feature selection may be provided, for example, via an output device operable to be read by a card reader. For example, the feature may be provided by a dynamic magnetic stripe communications device, an RFID antenna, an exposed IC chip, or any other type of card reader. For online purchases, for example, a display may be provided on the card and a user selection may cause a particular number (e.g., a particular code) to be displayed on the card. Such a code may be entered into a text box on a website at checkout and may be representative of the user's desired feature. Accordingly, the feature may be communicated to a remote server such that the feature may be performed in the third party service on behalf of the user. The code may additional provide the benefits of a security code and may be entered with a payment card number (e.g., a credit or debit card number) at online or in-store checkout.

Rewards may be awarded based on the amount of a purchase. Such rewards may be associated with a third party service or a card issuer, device or card provider, or other entity. For example, an amount of game currency may be awarded by a game provider at every purchase instead of a card issuer providing an amount of points, miles, or cashback to a user. Alternatively, for example, a user may earn both rewards from a card issuer as well as rewards from a third party service provider. A user may select, via, for example, physical buttons on the card or virtual buttons on a capacitive-sensitive display of a mobile telephonic device, the type of feature the user desires. Multiple features may be provided from a particular third party service provider. For example, a game service provider may provide a feature associated with one game action and another feature associated with another game action.

A card may include a dynamic magnetic communications device. Such a dynamic magnetic communications device may take the form of a magnetic encoder or a magnetic emulator. A magnetic encoder may change the information located on a magnetic medium such that a magnetic stripe reader may read changed magnetic information from the magnetic medium. A magnetic emulator may generate electromagnetic fields that directly communicate data to a magnetic stripe reader. Such a magnetic emulator may communicate data serially to a read-head of the magnetic stripe reader.

All, or substantially all, of the front as well as the back of a card may be a display (e.g., bi-stable, non bi-stable, LCD, LED, or electrochromic display). Electrodes of a display may be coupled to one or more capacitive touch sensors such that a display may be provided as a touch-screen display. Any type of touch-screen display may be utilized. Such touch-screen displays may be operable of determining multiple points of touch. Accordingly, a barcode may be displayed across all, or substantially all, of a surface of a card. In doing so, computer vision equipment such as barcode readers may be less acceptable to errors in reading a displayed barcode.

A card may include a number of output devices to output dynamic information. For example, a card may include one or more RFIDs or IC chips to communicate to one or more RFID readers or IC chip readers, respectively. A card may include devices to receive information. For example, an RFID and IC chip may both receive information and communicate information to an RFID and IC chip reader, respectively.

A device for receiving wireless information signals may be provided. A light sensing device or sound sensing device may be utilized to receive information wirelessly. A card may include a central processor that communicates data through one or more output devices simultaneously (e.g., an RFID, IC chip, and a dynamic magnetic stripe communications device). The central processor may receive information from one or more input devices simultaneously (e.g., an RFID, IC chip, dynamic magnetic stripe devices, light sensing device, and a sound sensing device). A processor may be coupled to surface contacts such that the processor may perform the processing capabilities of, for example, an EMV chip. The processor may be laminated over and not exposed such that such a processor is not exposed on the surface of the card.

A card may be provided with a button in which the activation of the button causes a code to be communicated through a dynamic magnetic stripe communications device (e.g., the subsequent time a read-head detector on the card detects a read-head).

The code may be indicative of, for example, a feature (e.g., a payment feature). The code may be received by the card via manual input (e.g., onto buttons of the card) or via a wireless transmission (e.g., via light, electromagnetic communications, sound, or other wireless signals). A code may be communicated from a webpage (e.g., via light and/or sound) to a card. A card may include a display such that a received code may be visually displayed to a user. In doing so, the user may be provided with a way to select, and use, the code via both an in-store setting (e.g., via a magnetic stripe reader) or an online setting (e.g., by reading the code from a display and entering the code into a text box on a checkout page of an online purchase transaction).

A remote server, such as a payment authorization server, may receive the code and may process a payment differently based on the code received. For example, a code may be a security code to authorize a purchase transaction. A code may provide a payment feature such that a purchase may be made with points, debit, credit, installment payments, or deferred payments via a single payment account number (e.g., a credit card number) to identify a user and a payment feature code to select the type of payment a user desires to utilize.

A dynamic magnetic stripe communications device may include a magnetic emulator that comprises an inductor (e.g., a coil). Current may be provided through this coil to create an electromagnetic field operable to communicate with the read-head of a magnetic stripe reader. The drive circuit may fluctuate the amount of current travelling through the coil such that a track of magnetic stripe data may be communicated to a read-head of a magnetic stripe reader. A switch (e.g., a transistor) may be provided to enable or disable the flow of current according to, for example, a frequency/double-frequency (F2F) encoding algorithm. In doing so, bits of data may be communicated.

Electronics may be embedded between two layers of a polymer (e.g., a PVC or non-PVC polymer). One or more liquid polymers may be provided between these two layers. The liquid polymer(s) may, for example, be hardened via a reaction between the polymers (or other material), temperature, or via light (e.g., an ultraviolet or blue spectrum light) such that the electronics become embedded between the two layers of the polymer and a card is formed.

A payment card or other device may receive information indicative of a feature desired to be added by a user. The payment card may communicate information indicative of the feature with payment card data associated with the card or a user selection. The payment data and feature information may be routed, for example, to an authorization server. The authorization server may authorize payment and, based on the authorized payment, communicate the feature information to a remote server. The remote server may utilize this remote information to impact a third party service. The feature information may, for example, be routed before the payment card data reaches an authorization server. At merchant settlement, charge backs may for a purchase associated with a game action may cause the feature to be reversed or a different feature to be implemented (e.g., a removal of rewards earned at authorization). The feature may be implemented at settlement upon confirmation that, for example, no chargeback was associated with the payment transaction.

A graphical user interface (GUI) may be provided to allow users to display one or more application managers and one or more application provider interfaces. The GUI may be rendered onto a display of a device (e.g., a powered card, a mobile telephonic device, an electronic tablet, a laptop computer, or a desktop computer) and may allow a user to configure features that are desired to be added by the user.

A user may, for example, associate a device or card with one or more third party service features using the application manager. Such an application manager may manage an ecosystem of applications and payment method cards where users within the ecosystem may manage which application(s) may be associated with a particular payment method card. A user may alter such associations at any time. Prior to associating one or more applications to a particular payment method card, the payment method card may be associated with one or more default applications that may be later modified by the user.

A GUI may be provided to administer a third party application that facilitates and monitors charitable contributions that may be initiated by a card or device during or after completing a purchase with the card or device. Charitable gifts may, for example, be selected by the user, such that when a purchase is conducted with the card or device, the selected gift is donated to the charity of that user's choice.

Charitable gifts may be purchased outright by the user based on an additional charge (e.g., a piggyback charge) that may be added to the user's purchase. Contributions toward the purchase of a charitable gift may be incrementally applied each time the user conducts a purchase transaction with his/her card or device. Charitable gifts may be purchased outright, or incrementally, where the purchases may not be based on any purchase activity at all (e.g., when a user checks in at a particular merchant by swiping a card or device through a merchant's terminal).

Charitable gifts (e.g., money donations) may be accumulated for a charity of a user's choice based upon performance metrics. Such performance metrics may award charitable gifts based on user purchase activity that may be based on one or more performance parameters, such as which card or device was used for a purchase, the amount of the purchase, the number of times a particular card or device was used for purchases, and which merchant was patronized during the purchase transaction. Merchants may, for example, match at least a portion of a charitable donation provided by a patronizing customer.

Charitable contributions provided by each user may be displayed onto a publicly visible medium associated with that user (e.g., that user's social networking webpage). Such a publicly visible medium may track the user's progress toward a charitable contribution goal (e.g., an accumulated amount of money to date that the user has earned towards a charitable contribution goal). Other communication mediums (e.g., a short messaging system or an email system) may be used to communicate a user's charitable contribution history and/or charitable contribution goal updates to one or more recipients of such communications (e.g., followers on a user's twitter account). A group of users may collaborate toward a charitable contribution goal and each user may be updated with a history and performance level of such a collaborative goal.

Charitable contributions may be selected based on one or more criteria. For example, a user may direct (e.g., via a GUI) that charitable contributions be made on a particular day (e.g., the first Monday of every month). A user may direct that charitable contributions be made to a particular charity at a particular address (e.g., to a user's particular place of worship every day during observance of lent).

A user may earn collectables (e.g., trading cards, stamps, and coins) provided by a third party based upon one or more performance metrics (e.g., the purchase history of a user using a particular card or device). A user may direct (e.g., via a GUI) which collectable from a set of collectables may be earned. A user's experience may be enhanced by sharing a history of collectable progression via a public medium associated with that user (e.g., the user's Facebook wall or the user's Twitter account).

### BRIEF DESCRIPTION OF THE DRAWINGS

The principles and advantages of the present invention can be more clearly understood from the following detailed description considered in conjunction with the following drawings, in which the same reference numerals denote the same structural elements throughout, and in which:

FIG. 1 is an illustration of a card and architecture constructed in accordance with the principles of the present invention;

FIG. 2 is an illustration of a device constructed in accordance with the principles of the present invention;

FIG. 3 is an illustration of a network topology constructed in accordance with the principles of the present invention;

FIG. 4 is an illustration of a GUI constructed in accordance with the principles of the present invention;

FIG. 5 is an illustration of a GUI constructed in accordance with the principles of the present invention;

FIG. 6 is an illustration of a process flow chart constructed in accordance with the principles of the present invention;

FIG. 7 is an illustration of a GUI constructed in accordance with the principles of the present invention;

FIG. 8 is an illustration of a process flow chart constructed in accordance with the principles of the present invention;

FIG. 9 is an illustration of a GUI constructed in accordance with the principles of the present invention;

FIG. 10 is an illustration of a process flow chart constructed in accordance with the principles of the present invention; and

FIG. 11 is an illustration of a GUI constructed in accordance with the principles of the present invention.

### DETAILED DESCRIPTION OF THE INVENTION

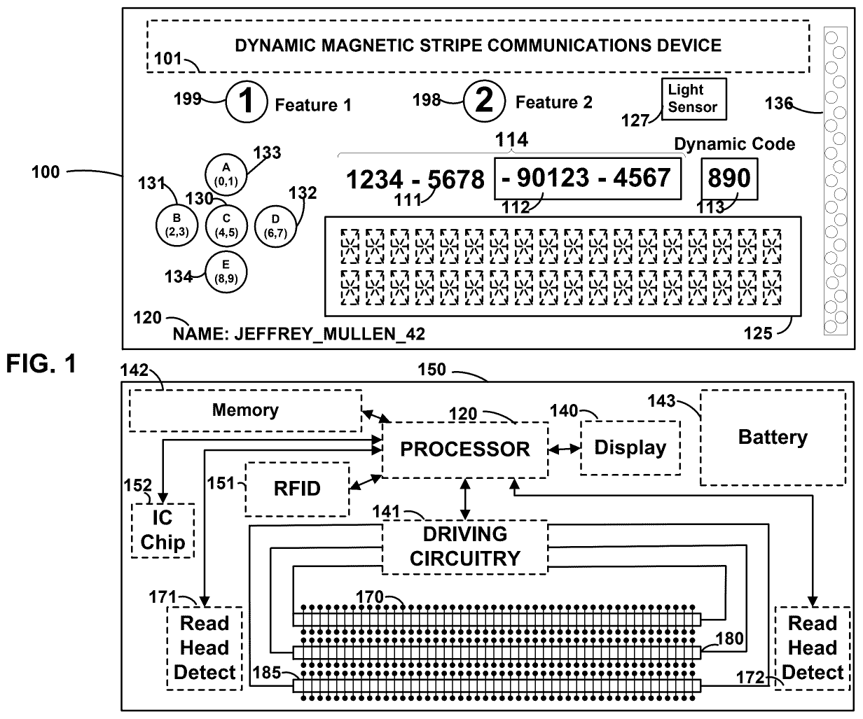

FIG. 1 shows card 100 that may include, for example, dynamic magnetic stripe communications device 101, one or more displays (e.g., displays 112, 113 and 125), permanent information 120, light sensor 127, one or more buttons (e.g., buttons 130-134, 198 and 199) and dynamic number 114 which may include a permanent portion 111. Permanent portion 111 may be, for example, printed, embossed and/or laser etched on card 100.

Multiple displays may be provided on card 100 for various purposes. For example, display 112 may display a dynamic number entirely, and/or partially. Display 113 may be utilized to display a dynamic code (e.g., a dynamic security code). Display 125 may display logos, barcodes, and/or multiple lines of information. A display (e.g., at least one of displays 112, 113 and 125) may be a bi-stable display or non bi-stable display. A bi-stable display may be a display that maintains an image without power.

Card 100 may include permanent information 120 including, for example, information specific to a user (e.g., a user's name and/or username) and/or information specific to a card (e.g., a card issue date and/or a card expiration date).

Card 100 may include one or more buttons, for example, buttons 130-134. Buttons 130-134 may be mechanical buttons, capacitive buttons, or a combination of mechanical and capacitive buttons. Card 100 may include button 199. Button 199 may be used, for example, to communicate information through dynamic magnetic stripe communications device 101 indicative of a user's desire to communicate a single track of magnetic stripe information. Persons skilled in the art will appreciate that pressing a button (e.g., button 199) may cause information to be communicated through device 101 when an associated read-head detector detects the presence of a read-head of a magnetic stripe reader.

Button 198 may be utilized to communicate (e.g., after button 198 is pressed and after a read-head detects a read-head of a reader) information indicative of a user selection (e.g., to communicate two tracks of magnetic stripe data). Multiple buttons may be provided on a card and each button may be associated with a different user selection.

Card 100 may include light sensor 127. Light sensor 127 may, for example, receive information from a light source (e.g., a display of a mobile telephonic device and/or a laptop computer). Card 100 may include, for example, any number of light sensors 127. Light sensor 127 may be utilized such that a display screen, or other light emitting device, may communicate information to light sensors 127 via light. Display 125 may allow a user to select (e.g., via buttons) options on display 125 that instruct the card to communicate (e.g., via a dynamic magnetic stripe communications device, RFID and/or exposed IC chip) to use a debit account, credit account, pre-paid account, and/or point account for a payment transaction.

Button 198 and button 199 may each be associated with, for example, a different third party service provider feature (e.g., an application facilitating a charitable donation and/or a collectable reward) and may be changed by a user at any time. LED array 136 may, for example, provide visible indicia of a charitable donation and/or a collectable reward. For example, LED array 136 may blink or emit a color of light that is indicative of whether a charitable contribution or a collectable reward was selected.

The third party feature associated with a button may be changed by a user, for example, on a graphical user interface (GUI) provided by a device provider, application manager provider, remote facility provider, card issuer, processor, and/or any other entity (which may be the same or different entities). For example, a third party service provider may, on its website and/or via an application, allow a user to change the third party feature performed when the third party's feature button is selected by a user on the user's card or other device.

For example, suppose a third party service provider provides a virtual collectable and then presents the fact the user has received the virtual collectable on a profile page of the user. When a transaction is performed, a user's profile may be updated to state that the user has been awarded a virtual collectible and the user may receive the virtual collectable (e.g., via email). Another action may be to donate to a charity based on a particular transaction. When a particular transaction is performed, a user's profile may be updated to indicate that the user has made a donation towards a charitable gift and/or donated a charitable gift. For example, a user may be provided with a GUI, for example, a GUI on a mobile telephonic device of the user when the user makes a purchase, to identify the collectable and/or donation associated to the user.

The selection of a feature may or may not have a cost associated with it. If a cost is associated with the feature, for example, the cost may be added to a customer's statement (e.g., added to a credit or debit purchase) for a particular transaction. A fixed-fee or variable-fee (e.g., a percentage of the transaction) may then be removed from the fee charged to the user and distributed among particular parties (e.g., distributed among the card issuer, application manager provider, ecosystem provider, device provider and/or other entity). The remainder of the fee may be provided, for example, to the third party service provider.

A cost may be associated to a feature selection, but may not be a cost to a user. For example, the cost may be a cost to a third party service provider (e.g., matching donations). The cost may be provided to other entities, for example, the device provider, card issuer, card processor (which may be the same, for example, as the card issuer), and/or any other entity (e.g., card network).

Architecture 150 may be utilized with any card (e.g., any card 100). Architecture 150 may include, for example, processor 120, display 140, driving circuitry 141, memory 142, battery 143, radio frequency identification (RFID) 151, integrated circuit (IC) chip 152, electromagnetic field generators 170, 180, and 185, and read-head detectors 171 and 172.

Processor 120 may be any type of processing device, for example, a central processing unit (CPU) and/or a digital signal processor (DSP). Processor 120 may be, for example, an application specific integrated circuit (ASIC). Processor 120 may include on-board memory for storing information (e.g., drive code). Any number of components may communicate to processor 120 and/or receive communications from processor 120. For example, one or more displays (e.g., display 140) may be coupled to processor 120. Persons skilled in the art will appreciate that components may be placed between particular components and processor 120. For example, a display driver circuit may be coupled between display 140 and processor 120.

Memory 142 may be coupled to processor 120. Memory 142 may store data, for example, data that is unique to a particular card. Memory 142 may store any type of data. For example, memory 142 may store discretionary data codes associated with buttons of a card (e.g., card 100 of FIG. 1). Discretionary data codes may be recognized by remote servers to effect particular actions. For example, a discretionary data code may be stored in memory 142 and may be used to cause a third party service feature to be performed by a remote server (e.g., a remote server coupled to a third party service such as an online voucher and/or coupon provider).

Different third party features may be, for example, associated with different buttons and a particular feature may be selected by pressing an associated button. According to some example embodiments, a user may select a third party feature from a list displayed to the user. For example, the user may scroll through a list of features on a display (e.g., a display on the front of the card). A user may scroll through a list using buttons on a card (e.g., card 100 of FIG. 1). The list of features may be displayed to the user individually (e.g., one or more buttons may be used to change which feature is displayed), in groups and/or all features may be simultaneously displayed.

According to at least one example embodiment, a user may select a type of payment on card 100 via manual input interfaces. The manual input interfaces may correspond to displayed options (e.g., displayed on display 125). Selected information may be communicated to a magnetic stripe reader via a dynamic magnetic stripe communications device. Selected information may also be communicated to a device (e.g., a mobile telephonic device) including a capacitive sensor and/or other type of touch sensitive sensor.

Architecture 150 may include any number of reader communication devices. For example, architecture 150 may include at least one of IC chip 152, RFID 151 and a magnetic stripe communications device. IC chip 152 may be used to communicate information to an IC chip reader (not illustrated). IC chip 152 may be, for example, an EMV chip. RFID 151 may be used to communicate information to an RFID reader. RFID 151 may be, for example, an RFID tag. A magnetic stripe communications device may be included to communicate information to a magnetic stripe reader. For example, a magnetic stripe communications device may provide electromagnetic signals to a magnetic stripe reader.

Different electromagnetic signals may be communicated to a magnetic stripe reader to provide different tracks of data. For example, architecture 150 may include electromagnetic field generators 170, 180, and 185 to communicate separate tracks of information to a magnetic stripe reader. Electromagnetic field generators 170, 180, and 185 may include a coil (e.g., each may include a coil) wrapped around one or more materials (e.g., a soft-magnetic material and a non-magnetic material). Each electromagnetic field generator may communicate information, for example, serially to a receiver of a magnetic stripe reader for a particular magnetic stripe track.

Card 100 may include a dynamic magnetic communications device. Such a dynamic magnetic communications device may take the form of a magnetic encoder or a magnetic emulator. A magnetic encoder may change the information located on a magnetic medium such that a magnetic stripe reader may read changed magnetic information from the magnetic medium. A magnetic emulator may generate electromagnetic fields that directly communicate data to a magnetic stripe reader. Such a magnetic emulator may communicate data serially to a read-head of the magnetic stripe reader.

Architecture 150 may include read head detectors 171 and 172. Read-head detectors 171 and 172 may be configured to sense the presence of a magnetic stripe reader (e.g., a read-head housing of a magnetic stripe reader). Information sensed by the read-head detectors 171 and 172 may be communicated to processor 120 to cause processor 120 to communicate information serially from electromagnetic generators 170, 180, and 185 to magnetic stripe track receivers in a read-head housing of a magnetic stripe reader.

According to at least one example embodiment, a magnetic stripe communications device may change the information communicated to a magnetic stripe reader at any time. Processor 120 may, for example, communicate user-specific and card-specific information through RFID 151, IC chip 152, and/or electromagnetic generators 170, 180, and 185 to card readers coupled to remote information processing servers (e.g., purchase authorization servers). Driving circuitry 141 may be utilized by processor 120, for example, to control electromagnetic generators 170, 180, and 185.

Architecture 150 may include, for example, a light sensor. Architecture 150 may receive information from a light sensor. Processor 120 may determine information received by a light sensor.

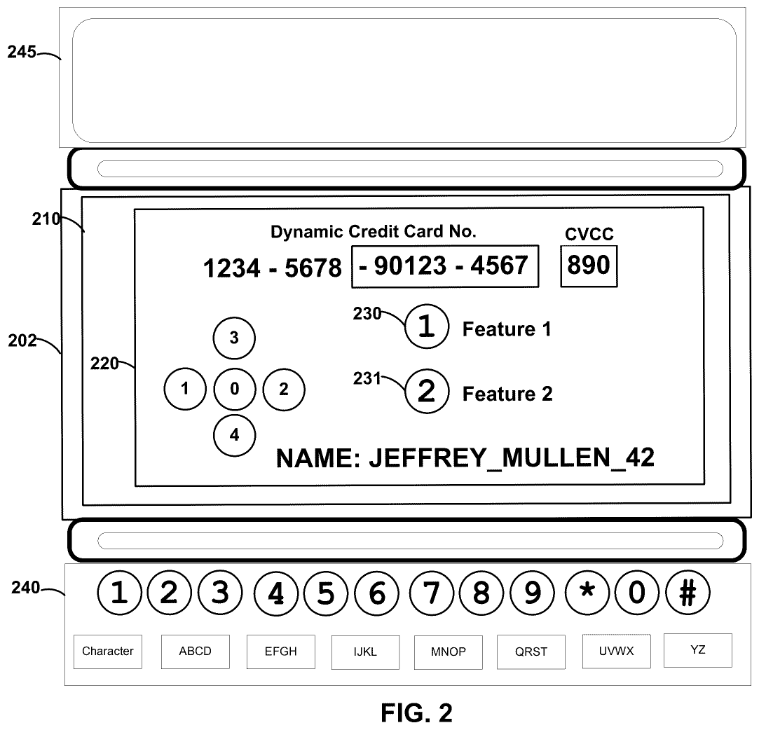

FIG. 2 shows device 200 that may be, for example, a mobile telephonic device and/or other device (e.g., portable computer such as a portable tablet computer). Device 200 may include, for example, housing 202, display 210, device card 220, physical buttons 240, and virtual buttons 230 and 231.

Display 210 may include, for example, light-sensitive and/or touch-sensitive elements. Device 200 may communicate information to a card reader, for example, via a contactless signal (e.g., an RFID signal) and/or a contact-based signal (e.g., a USB connection).

Device 200 may include a device card 220 and/or virtual buttons 230 and 231. Device card 220 may be a virtual representation of a card and/or any information identifying a payment method (e.g., credit account number). A person skilled in the art will appreciate that any physical card described herein may be provided as a device card on, for example, a computing system (e.g., a mobile telephonic device and/or a computer). Physical buttons of a physical card may, for example, correspond to virtual buttons of a device card.

Virtual button 230 may, for example, correspond to one feature (e.g., an application directed to charitable gifts) from one third party service provider while virtual button 231 may, for example, correspond to another feature (e.g., an application providing a user the opportunity to obtain a collectable) from another third party service provider. According to at least one example embodiment, every feature may not be provided by a third party service provider. Persons skilled in the art will appreciate that the device provider may, for example, provide features.

All features for a card may be utilized, for example, with a particular payment account (e.g., a credit account) such that a payment transaction with that payment account is performed if any feature is selected. As another example, one or more features may be associated with a payment account (e.g., a credit account) while an additional one or more features may be associated with a different payment account (e.g., a debit account). Accordingly, a selected feature associated with a credit account may be utilized to make a purchase with credit and may perform an additional action associated with that feature. A different selected feature associated with a debit account may be utilized to make a purchase with debit and may perform an additional action associated with that different feature.

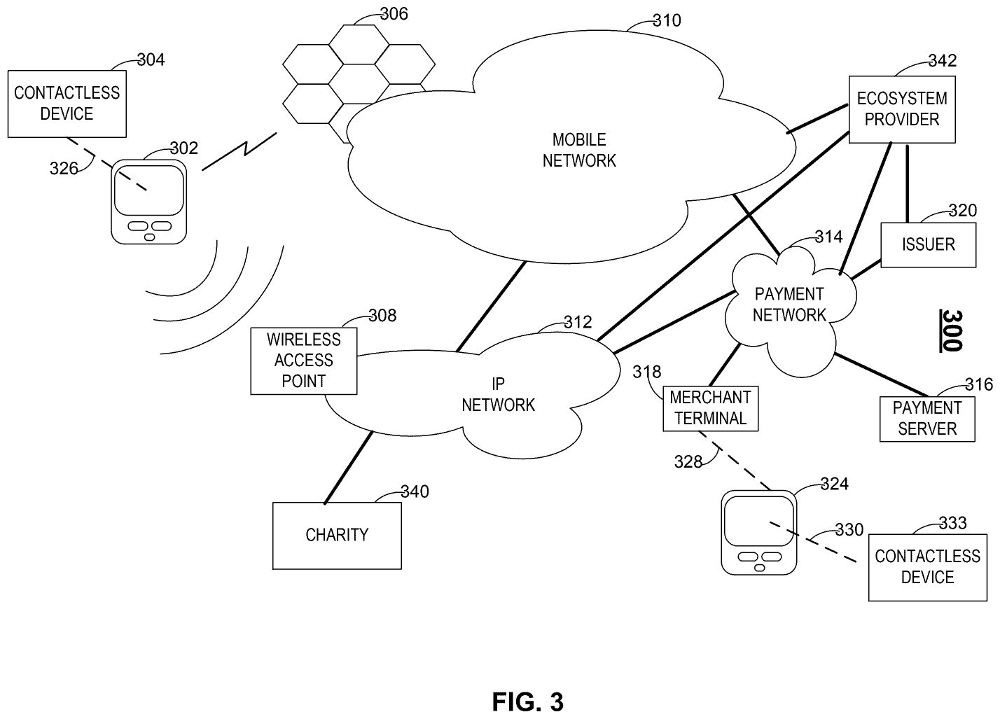

FIG. 3 shows network topology 300 that may include, for example, mobile device 302 (e.g., a mobile telephonic device, a PDA, an electronic tablet, a laptop, a GPS unit, or an MP3 player). Mobile device 302 may, for example, include a contactless interface that may initiate, sustain, and/or terminate communication channel 326 between contactless device 304 and mobile device 302. Contactless device 304 and mobile device 302 may communicate via channel 326 using any number of contactless mediums, which may include for example, visible, audible, capacitive, electromagnetic, magnetic, and/or RF mediums.

Mobile device 302 may provide one or more transceivers that may communicate with one or more wired networks (e.g., IP network 312 and/or payment network 314) and/or one or more wireless networks (e.g., mobile network 310). Mobile device 302 may, for example, communicate with a cellular station over a wireless radio interface (e.g., a GSM air interface) that may be used by mobile device 302 to communicate information (e.g., voice and data) to cellular network access infrastructure 306 (e.g., one or more GSM base transceiver stations, base station controllers and mobile switching centers). Persons skilled in the art will appreciate that cellular network access infrastructure 306 may utilize any multiple access architecture, such as for example, a code-division multiple access architecture and/or a time-division multiple access architecture.

Mobile device 302 may, for example, communicate with wireless access point 308 over a wireless interface (e.g., a Bluetooth interface or a Wi-Fi interface). Accordingly, for example, mobile device 302 may access one or more wired networks (e.g., IP network 312 and/or payment network 314) and/or one or more wireless networks (e.g., mobile network 310) without the need to first gain access to cellular network access infrastructure 306.

Contactless device 304 may, for example, be a powered card or a non-powered card (e.g., a powered payment card or a non-powered payment card). Accordingly, for example, payment information (e.g., a payment account number and a card expiration date) may be communicated from contactless device 304 to mobile device 302 in support of a financial transaction being conducted by mobile device 302. In so doing, for example, items for purchase on IP network 312 (e.g., the internet) may be accessed by a browser of mobile device 302 via an access point (e.g., wireless access point 308 or cellular network access infrastructure 306). Mobile device 302 may, for example, complete a purchase transaction by first obtaining required payment information from contactless device 304 and then communicating such payment information to network entities (e.g., payment server 316 and/or issuer 320). Mobile device 302 may, for example, already contain payment information necessary to complete a purchase transaction. Accordingly, for example, mobile device may not need to obtain payment information from contactless device 304 before completing a purchase transaction.

Payment server 316 may, for example, contact issuer 320 via a network (e.g., payment network 314) with payment information received from mobile device 302 for authorization of a purchase. Once authorized, payment transaction information may be recorded onto a receipt that may be delivered to mobile device 302 via any one or more delivery options (e.g., via a short messaging service of mobile network 310 or an email delivery service of IP network 312).

A payment receipt may, for example, be provided to mobile device 302 as a proof-of-purchase object (e.g., a barcode) that may be provided to a display of mobile device 302 and read by other computing equipment (e.g., a barcode scanner) for proof-of-purchase confirmation.

A mobile device (e.g., mobile device 324) may, for example, include a contactless communication device (e.g., an RFID) that may initiate, sustain, and/or terminate contactless communication channel 328 with merchant terminal 318. Accordingly, for example, mobile device 324 may communicate payment information to merchant terminal 318 to complete a financial transaction. In so doing, for example, mobile device 324 may first receive payment information via contactless communication channel 330 from contactless device 333 (e.g., a non-powered card), temporarily store the received payment information within a memory of mobile device 324, and forward the payment information onto merchant terminal 318 to complete a financial transaction. As per another example, mobile device 324 may provide previously stored financial information associated with one or more payment cards (e.g., one or more non-powered payment cards). Accordingly, for example, payment information may be recalled from a memory of mobile device 324 and communicated to merchant terminal 318 via contactless communication channel 328 to complete a financial transaction using merchant terminal 318.

Charity server 340 may communicate with one or more wired networks (e.g., IP network 312 and/or payment network 314) and/or one or more wireless networks (e.g., mobile network 310). Charity server 340 may communicate directly and/or indirectly with different entities. For example, charity server 340 may exchange information (e.g., transactional data) with mobile devices 302 and 324, a third party application provider, an application manager provider, an ecosystem provider, issuer 320, merchant terminal 318, payment network 314, payment server 316, a remote facility and/or other entities. Charity server 340 may be, for example, a server supporting charitable applications of a charitable application provider (e.g., a charity).

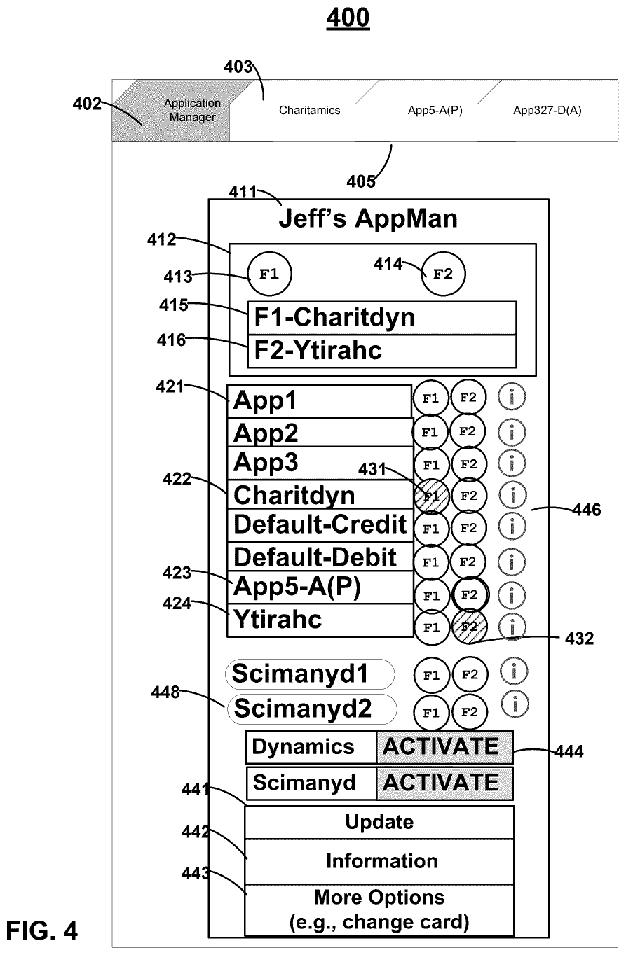

FIG. 4 shows GUI 400 that may include tabs 405, text 411, virtual card 412, virtual indicia 413 and 414, field descriptors 415 and 416, application identifiers 421-424, and selection options 431, 432, and 441-443. GUI 400 may be displayed on, for example, a computer monitor, mobile phone touch screen, and/or the like.

Tabs 405 may include one or more tabs used to display one or more application managers and one or more application provider screens (e.g., screens to configure third party applications). For example, tab 402 may be selected by a user (e.g., with a keyboard, mouse, touch sensitive screen and/or electronic pointer) to display an application manager using GUI 400. Tab 403 may be selected by a user to display, for example, application configurations for an application provider “Charitamics” (e.g., a third party application provider).

A user may associate a payment method card (e.g., a powered physical card, non-powered physical card and/or device card) with third party service features using the application manager. An application manager may be provided, for example, on a remote facility and displayed on GUI 400 to allow a user to change the third party service features associated with a card. An application manager may manage an ecosystem of applications and payment method cards, and the user may utilize GUI 400 to, for example, associate a particular feature to a particular payment method card at any time. The user may associate the selected feature with a card and/or a card button. According to example embodiments, an ecosystem provider may be different than an application manager provider and/or other entities. One or more of the functions described herein as being performed by an application manager provider and/or other entities may be performed by the ecosystem provider. According to at least one example embodiment, an ecosystem provider may act as an application manager provider, application provider, issuer, merchant, payment network and/or the like to provide an end-to-end experience.

Persons skilled in the art will appreciate that a default feature may be provided and/or that a number of features provided by a card issuer or other entity may be provided in addition to third party service features. For example, a card issuer may provide a card with a default of credit on one button and a default of decoupled debit on a second button. A user may press the first button to perform a credit transaction. A user may press the second button to perform a decoupled debit transaction.

Virtual card 412 may be provided as a representation of a user's physical and/or device card. A user may be provided with the ability to change between multiple different cards and configure the features associated with those multiple cards. Accordingly, virtual card 412 may be provided with indicia 413 in the configuration of, and indicative of, one button of a user's card, and virtual card 412 may be provided with indicia 414 in the configuration of, and indicative of, another button of a user's card. Fields 415 and 416 may display the features currently associated to each button. Accordingly, a user may, for example, view virtual card 412 in order to refresh the user's memory with respect to the features associated with the buttons on a user's physical and/or device card (not shown).

Text 411 may, for example, identify the user associated with virtual card 412 and the corresponding physical card (not shown). GUI 400 may be, for example, provided as an application for a device (e.g., a computer, a portable computing device and/or a mobile telephonic device) and/or retrieved information from a web browser.

A list of applications may be provided on GUI 400. Each application may provide third party service provider features. A user may, for example, associate features provided by different applications with a particular card and/or one or more buttons on a card. For example, selection 431 may associate application 422 to the button of a card associated with virtual button 413. Selection 432 may associate application 424 to the button of a card associated with virtual button 314. Accordingly, a user may change the features associated to a card by using GUI 400. The list of features may be, for example, all features or a limited subset of all features available to a user through an application manager.

A physical and/or device card (not shown) may communicate information indicative of a button that was pressed on the physical and/or device card, along with or separate from other payment data (e.g., an account number, security code, and other data). For example, information indicative of the button that was pressed may be included in discretionary data of a payment message. A payment message may be, for example, one or more tracks of magnetic stripe data (e.g., communicated from a dynamic magnetic stripe communications device), an RFID message (e.g., a near field communication (NFC) message from a radio frequency antenna), and/or an exposed IC chip message (e.g., an EMV message) from an exposed IC chip.

The information indicative of which button was pressed may be passed to a card issuer and/or processor from a point-of-sale and any intermediary devices (e.g., a merchant acquirer processing server). The information may be passed to a remote facility (e.g., a facility providing an application manager) such that the remote facility may determine the button that was pressed by a user. This remote facility may, in turn, retrieve information associated with the third party feature (and/or a feature of a card issuer, processor, application manager provider, and/or any entity) and forward information to that feature provider such that the feature may be performed. Information may be returned to the entity that provided the information indicative of the button that the user pressed.

Persons skilled in the art will appreciate that if, for example, a non-powered card is utilized then information indicating that a button was pressed may not be available. With respect to a non-powered card, information indicative that a purchase was made may be provided to an application manager provider such that the application manager provider can initiate the desired feature for the non-powered card. For non-powered cards, for example, features may be associated with different types of purchases. For example, one feature may be provided for a particular merchant type (e.g., a trading card feature) and another feature may be provided for a different merchant type (e.g., a memorabilia feature). Features may be associated with other characteristics of a purchase such as, for example, a purchase above a particular amount (e.g., at or above $100) and/or a purchase below a particular amount (e.g., below $100). However, such additional feature selections are not limited to non-powered cards and may be provided to, for example, users of powered cards and devices.

GUI 400 may be provided, for example, on a card issuer's website. GUI 400 may be provided, for example, on a bill statement web page (e.g., provided above the bill statement or to the right of the bill statement). Accordingly, a user may utilize the application manager to manage application features when the user is logged into his/her account. Although example embodiments described with respect to FIG. 4 may describe a GUI 400 used to make various selections and/or associations, persons skilled in the art will appreciate that other methods are possible. For example, selections may be made by phone, email and/or the like.

A third party service provider may utilize GUI 400 as part of a user's administration and/or experience of that third party service. For example, a user's profile page for a third party service may include GUI 400. An application manager provider may provide web-code that retrieves GUI 400 from a remote facility managed by the application manager provider. Selection 441 may be utilized by a user to check for updates (e.g., confirm that a feature was changed and/or if any updates are present). Selection 442 may be utilized to explain the functionality of a particular application feature. Selection 443 may be utilized for additional selection options, for example, changing which card is displayed on an application manager.

According to at least one example embodiment, a card may be provided with one button for a particular payment account (e.g., credit) and one button for a changeable feature. Accordingly, a user may, for example, only need to remember one feature associated with a card. A credit account may include rewards, for example, points, cashback, and/or miles, from the card issuer. Accordingly, pushing the payment account button may earn the user such rewards. Pushing the changeable feature button may, alternatively, for example, not earn the user such rewards and may instead initiate a changeable feature. In doing so, for example, the cost of providing a card may be reduced in that the cost of rewards for the card may be reduced. A feature may include, for example, a feature from a third party application provider. The feature from the third party application provider may be, for example, the ability for a user to contribute towards a charitable gift.

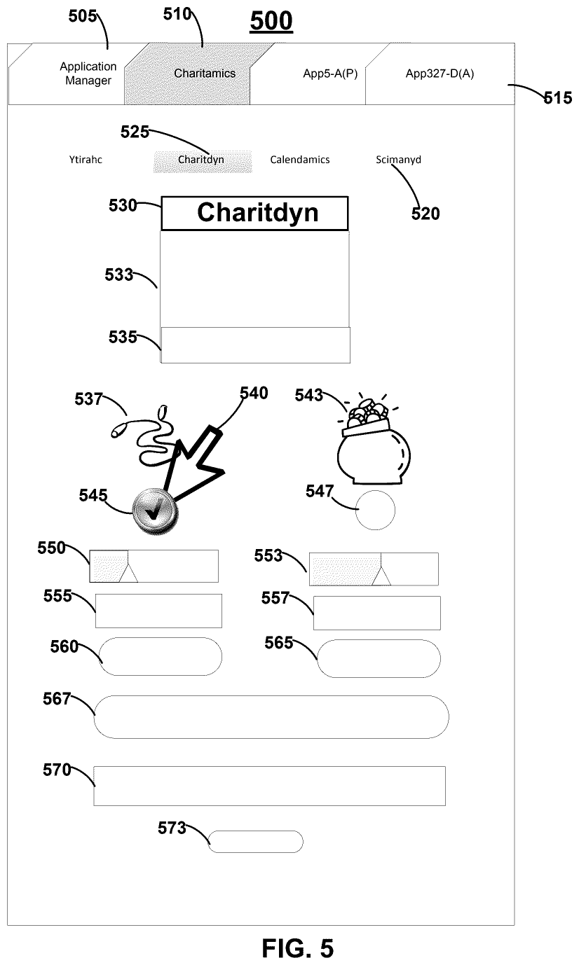

FIG. 5 shows GUI 500 that may include tabs 515, applications 520, application selection display 530, information display 533, contribution summation display 535, charitable gift displays 537 and 543, selections 545 and 547, contribution meters 550 and 553, contribution progress displays 555 and 557, selections 560 and 565, contribution history display 567, entry field 570, and/or selection 573.

Tabs 515 may include one or more tabs used to display one or more application managers (e.g., tab 505) and one or more tabs used to display one or more charitable application provider screens used to, for example, configure third party applications (e.g., tab 510). Although example embodiments may be described with respect to tabs, persons skilled in the art will appreciate that other methods of configuring features are contemplated. For example, redirection links may be provided to redirect a user to a configuration screen of an application provider.

Applications 520 may be selected to, for example, view different configuration screens for different applications provided by an application provider. For example, application 525 may be selected by a user to display a configuration screen for an application associated with a charitable application provider (e.g., “Charitamics”). Application selection display 530 may visually inform the user that application 525 is currently active. Display 533 may include information related to a charitable application provider, for example, a description of the services provided to charity recipients.

Each of applications 520 may provide one or more features to a user. A feature associated with application 525 may be the opportunity to donate to a charitable cause. For example, a user may select one or more charitable gifts displayed in charitable gift displays 537 and 543 (e.g., a jump rope and/or monetary value, respectively) using selection pointer 540. Selections 545 and 547 may be used to activate one or more features associated with charitable gift displays 537 and 543, and may indicate which features are active.

Charitable gifts identified by charitable gift displays 537 and 543 may be charitable gifts related to, for example, a private charity and/or a public charity (e.g., a charity described in section 501 (c) (3) of the Internal Revenue Code). For example, application 525 may be associated to a charitable cause operated by a military organization dedicated to distributing toys to children. Application 525 may provide a user with a selection from among charitable gifts related to the charity, for example, a gift represented in charitable gift display 537 (e.g., a jump rope). Although two charitable gift displays are illustrated in FIG. 5, one or more charitable gift displays may be included in GUI 500. For example, multiple rows of charitable gift displays and associated selections may be displayed. A user may scroll through the multiple rows of charitable gift displays using, for example, a scroll bar (not illustrated).

A user may select one or more charitable gifts as active features using, for example, selections 545 and 547. For example, selection 545 may activate a feature by which outright purchases of a charitable gift and/or contributions towards a charitable gift displayed in charitable gift display 537 may be made. Contributions towards an active charitable gift may be made, for example, using piggyback charges, third party charges, direct purchases and/or the like.

A piggyback charge may be a statement debit (charge) added to a user statement, for example, for each purchase using a card and/or a device card. A user may select an amount of the piggyback charge using, for example, GUI 500. A third party charge may be a monetary value provided by a third party application provider to a charitable provider on behalf of the user, for example, upon a user meeting a performance metric. A performance metric may include, for example, a purchase with a card (e.g., a physical and/or device card), a sequence of purchases (e.g., ten purchases), a total amount spent, and/or metrics related to various other purchasing and/or non-purchasing transactional events.

A direct purchase may be a partial or complete purchase of a charitable gift by a user that is not attached to any other purchase. For example, a vendor may provide functionality by which a user may swipe a card and/or communicate data of a device card to partially or wholly purchase a charitable gift without also purchasing any item from the vendor.

According to at least one example embodiment, a user may configure GUI 500 to facilitate contributions to a charitable gift not included as a choice on GUI 500. For example, GUI 500 may include a blank charitable gift display. Vendors may provide ‘drag-and-drop’ charitable gift icons (e.g., on a vendor website) representing a vendor item. A user may drag a vendor icon onto GUI 500 and GUI 500 may be automatically modified to include the charitable gift icon. The icon transfer may include billing information, for example, billing information invisible to a user that may be used by a charitable application to purchase a selected charitable gift. A vendor may provide incentives (e.g., matching donations) for use of a vendor product as a charitable gift. According to at least one example embodiment, GUI 500 may be fully configurable and, for example, both charitable gifts and charities may be specified by the user using an application accessed via GUI 500 (e.g., drag-and-drop charity icons).

An application accessed using GUI 500 may include configurable functionality to improve a user experience. For example, each charitable contribution and/or each purchased charitable gift may be publically and/or privately displayed (and/or a progression display may be updated). For example, charitable contribution information may be displayed on a user's social networking page, on a charitable provider web page, on a physical display at chosen location and/or the like. In order to provide configurable functionality, a charitable application provider and/or an application of a charitable application provider may be associated to the user during, for example, an activation process. A user requesting access to a charitable application may be prompted for information. The information may include, for example, security credentials used to access a social networking site associated with the user.

Contribution meters 550 and 553 may, for example, graphically indicate progress towards completion of a charitable donation. For example, meter 550 may indicate progress towards the purchase of a jump rope, and meter 553 may indicate progress towards a monetary amount (e.g., as the filling of a display bar). Contribution progress displays 555 and 557 may indicate the progress towards completion of a charitable donation as a dollar amount. For example, contribution progress displays 555 and 557 may indicate an amount required for completion of a charitable donation. Contribution summation display 535 may display, for example, a total amount contributed to date via the charitable application provider using the charitable application.

Selections 560 and 565 may, for example, activate an additional and/or independent feature. For example, selection 565 may be selected to contribute an amount required to complete monetary value 543, and selection 560 may be selected to contribute an amount remaining to purchase a charitable gift displayed in charitable gift display 537. The remaining amount may be, for example, immediately charged via GUI 500 and/or may be attached as a piggyback charge to a next purchase (e.g., a next purchase using a card and/or a device card).

Data may be entered into entry field 570 by a user. For example, a user may enter an email address of a recipient of a charitable gift. Selection 573 may be, for example, selected to enter the data entered into entry field 570, to update a charitable application and/or the like.

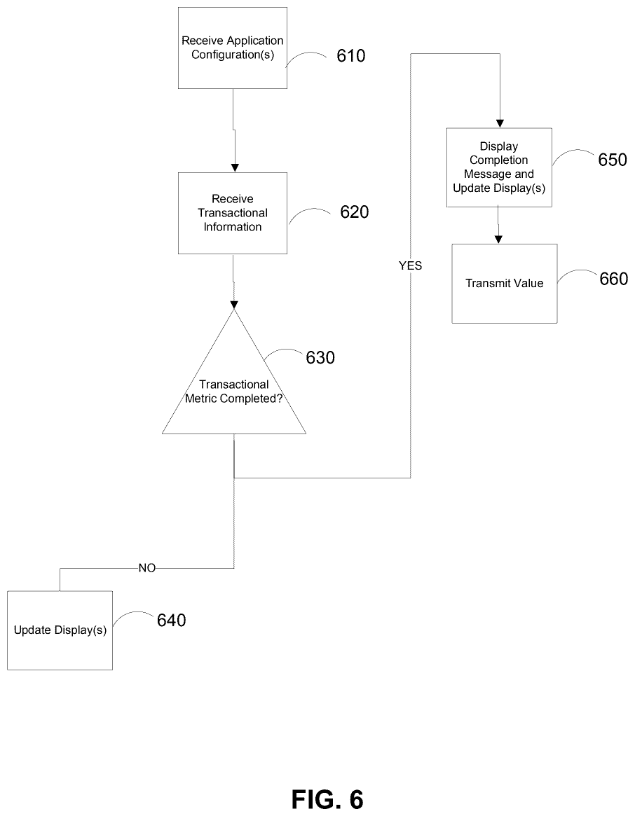

FIG. 6 shows process flow chart 600. A charitable application provider may receive user configuration selections (e.g., as in step 610) and transactional data from, for example, an application manager provider (e.g., as in step 620). The charitable application provider may associate the transactional data with a user and determine if a transactional metric has been completed (e.g., as in step 630). If a transactional metric has not been completed, the charitable application provider may update one or more displays based on the received transactional data (e.g., as in step 640). If a transactional metric has been completed, the charitable application provider may display a completion message to a user and update one or more displays (e.g., as in step 650). A value may be transmitted to, for example, a charitable recipient (e.g., as in step 660).

According to one non-limiting example embodiment, an animal protection organization may receive a user selection to donate a monetary value to an animal shelter. The animal protection organization may receive transactional information, for example, information indicative of a feature selected by a user, an amount spent and/or the like. Based on the information, the animal protection organization may determine if a transactional metric has been completed. For example, a transactional metric may include ten user purchases using a particular card. If the transactional metric has not been completed, a progression display (e.g., meter 550 and contribution progress display 555) may be updated. If a transactional metric has been met, an email may be sent notifying a user that a charitable donation has or will be made on behalf of the user. One or more progression displays may be updated and/or the user's name may be added to a web page listing the names of contributors. The charitable donation may be transmitted to the recipient, for example, the animal shelter selected by the user.

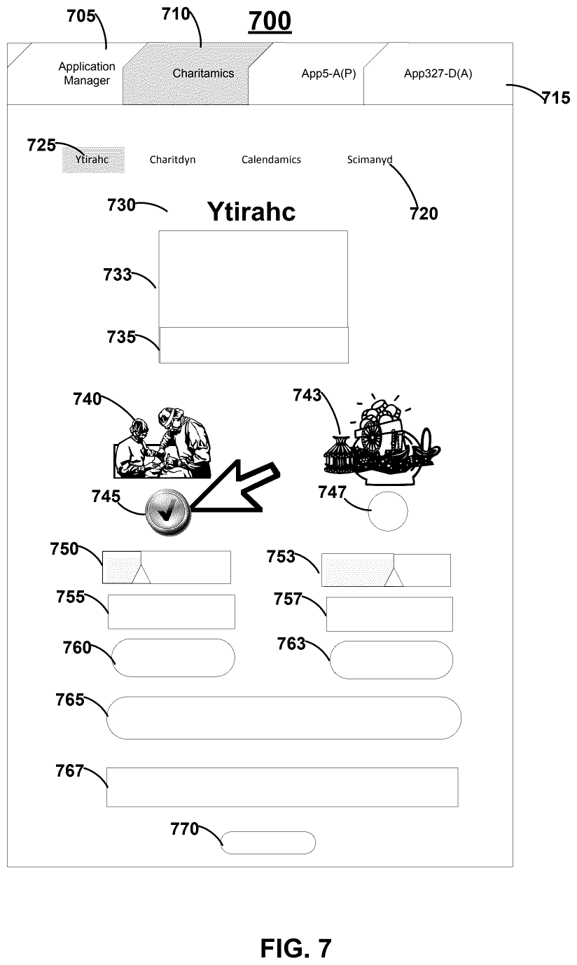

FIG. 7 shows GUI 700 that may include tabs 715, applications 720, application selection display 730, information display 733, contribution summation display 735, charitable gift displays 740 and 743, selections 745 and 747, contribution meters 750 and 753, contribution progress displays 755 and 757, selections 760 and 763, contribution history display 765, entry field 767, and/or selection 770.

Tabs 715 may include one or more tabs used to display one or more application managers (e.g., tab 705) and one or more tabs used to display one or more charitable application provider screens used to, for example, configure third party applications (e.g., tab 710).

Each of applications 720 may be selected to, for example, view different configuration screens for different applications provided by an application provider. For example, application 725 may be selected by a user to display a configuration screen for an application associated with a charitable application provider (e.g., “Charitamics”). Application selection display 730 may visually inform the user that application 725 is currently active. Display 733 may include information related to a charitable application provider, for example, a description of the services provided by a charitable provider.

Each of applications 720 may provide one or more features to a user. A feature associated with application 725 may be, for example, the opportunity to donate to a charitable cause. For example, a user may select one or more charitable gifts displayed in charitable gift displays 537 and 543 (e.g., a surgery and/or a vacation, respectively). Selections 745 and 747 may be used to activate one or more features associated with charitable gift displays 740 and 743, and may indicate which features are active.

Charitable gifts identified by charitable gift displays 740 and 743 may be charitable gifts related to, for example, a private charity and/or a public charity. Application 525 may provide a user with a selection from among charitable gifts related to the charity, for example, a gift represented in charitable gift display 740 (e.g., a surgery). Although two charitable gift displays are illustrated in FIG. 7, one or more charitable gift displays may be included in GUI 700. For example, multiple rows of charitable gift displays and associated selections may be displayed. A user may scroll through the multiple rows of charitable gift displays using, for example, an field expansion bar (not shown).

A user may select one or more charitable gifts as active features using, for example, selections 745 and 747. For example, selection of selection 745 may activate a feature by which a user may be added to a pool of users contributing towards a charitable gift displayed in charitable gift display 740. Contributions towards an active charitable gift may be made by each of the users within the pool of users, for example, using piggyback charges, third party charges, direct purchases and/or the like. Accordingly, expensive charitable gifts which may not be obtainable by an average user may be donated my multiple users acting in concert.

According to at least one example embodiment, a group of users may configure GUI 700 to facilitate contributions to a charitable gift not included as a choice on GUI 700. For example, GUI 700 may include a blank charitable gift display. Vendors may provide ‘drag-and-drop’ charitable gift icons (e.g., on a vendor website) representing a vendor item. A group of users may collectively request the addition of the charitable gift to GUI 700 and GUI 700 may be modified to include the charitable gift icon (e.g., by the application, by a charitable application provider and/or automatically using drag-and-drop functionality).

An application accessed using GUI 700 may include configurable functionality to improve a user experience. For example, each charitable contribution and/or each purchased charitable gift may be publically and/or privately displayed (and/or a progression display may be updated). For example, charitable contribution information may be displayed on a social networking page of each and/or a group of users, on a charitable provider web page, on a physical display at a chosen location, on a website dedicated to donating a particular charitable gift (e.g., for a particular charitable recipient) and/or the like. In order to provide configurable functionality, a charitable application provider and/or an application of a charitable application provider may be associated to each user during, for example, an activation process. Each user requesting to contribute to the charitable gift may be prompted for information. The information may include, for example, security credentials used to access a personal social networking site associated with the user and/or the like.

Contribution meters 750 and 753 may, for example, graphically indicate progress towards completion of a charitable donation. For example, meter 750 may indicate progress towards the purchase of a surgery (e.g., a heart replacement for a child), and meter 753 may indicate progress towards a vacation. The progress may be represented by the filling of the display bar. According to at least one example embodiment, contribution meters 750 and 753 may indicate an individual user's progress towards a portion of an overall donation (e.g., a fraction of the overall donation allocated and/or negotiated by the user), and may be viewable by only the user, to anyone accessing a website (e.g., dedicated to a terminally ill child) and/or one or more of the pool of users. Contribution progress displays 755 and 757 may indicate the progress towards completion of a charitable donation as a dollar amount. For example, contribution progress displays 755 and 757 may indicate an amount required for completion of a charitable donation and/or a portion of the charitable donation committed to by a user. Contribution summation display 735 may display, for example, a total amount contributed to date via the charitable application provider using the charitable application.

Selections 760 and 763 may each, for example, activate an additional and/or independent feature. For example, selection 760 may be selected to contribute an amount remaining to purchase a charitable gift displayed in charitable gift display 740, and selection 763 may be selected to contribute an amount remaining to purchase a charitable gift displayed in charitable gift display 743. The remaining amount may be an amount remaining of a fraction of the donation committed to by the user and/or the entire donation. The remaining amount may be, for example, immediately charged using GUI 700 and/or may be attached as a piggyback charge to a next purchase (e.g., a next purchase using a card and/or a device card).

Data may be entered into entry field 765 by a user. For example, a user may enter an email address of an organization providing the charitable service (e.g., a hospital), an organization organizing the pooled contributions and/or the like. Selection 770 may be, for example, selected to enter the data entered into entry field 770, to update a charitable application and/or the like.

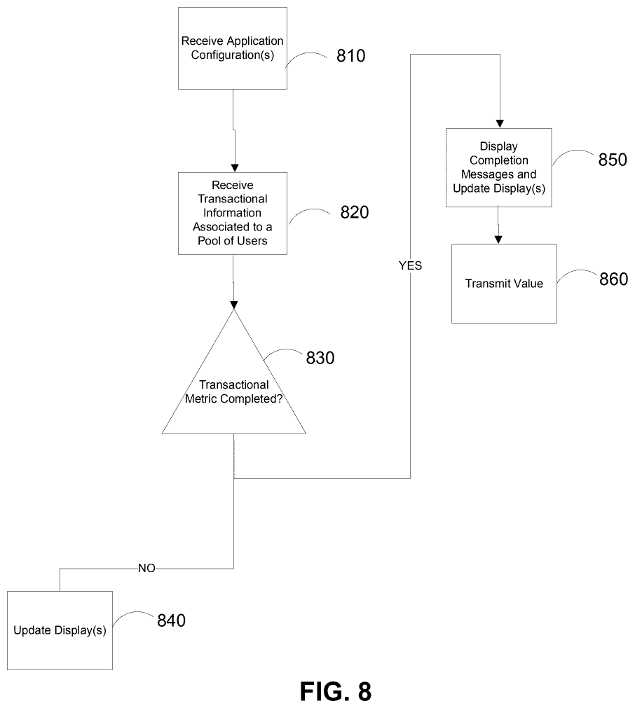

FIG. 8 shows process flow chart 800. A charitable application provider may receive user configuration selections (e.g., as in step 810). For example, user configuration selections may include identification of one or more common charitable gifts, identification of each user of a pool of users contributing to the charitable gift, an allocation of a required donation to each user, information required to provide additional functionality (e.g., security credentials), and/or identification of a recipient of the charitable gift (e.g., a person, an organization and location, and/or the like). The charitable application provider may receive transactional data associated to one or more of the users from, for example, an application manager provider (e.g., as in step 820) based on transactional activities of the users (e.g., purchases using a card and/or a device card). The charitable application provider may associate the transactional data with the pool of users and determine if a transactional metric has been completed with respect to the common charitable gift (e.g., as in step 830). If a transactional metric has not been completed, the charitable application provider may update one or more displays based on the received transactional data (e.g., as in step 840). If a transactional metric has been completed, the charitable application provider may display a completion message to each user of the pool of users and update one or more displays (e.g., as in step 850). A value may be transmitted to, for example, a charitable recipient (e.g., as in step 860).

According to one non-limiting example embodiment, a foundation dedicated to fulfilling desires of terminally ill children may receive a selection from a pool of users to donate a vacation to, for example, a terminally ill child local to the users. The foundation may receive transactional information, for example, information indicative of a feature selected by the pool of users, an amount spent by one or more of the users and/or the like. Based on the information, the foundation may determine if a transactional metric has been completed by the collective. For example, a transactional metric may include 1,000,000 user purchases using cards and/or device cards. If the transactional metric has not been completed, a progression display (e.g., meter 750 and contribution progress display 755) may be updated. If a transactional metric has been met, a text message may be sent notifying each of the pool of users that a charitable donation has or will be made on behalf of the pool of users. One or more progression displays may be updated and/or the user's and/or pool of user's name(s) may be added to a web page dedicated to the charitable recipient along with information related to the donation. The charitable donation may be transmitted to the recipient, for example, paid for reservations and/or the like.

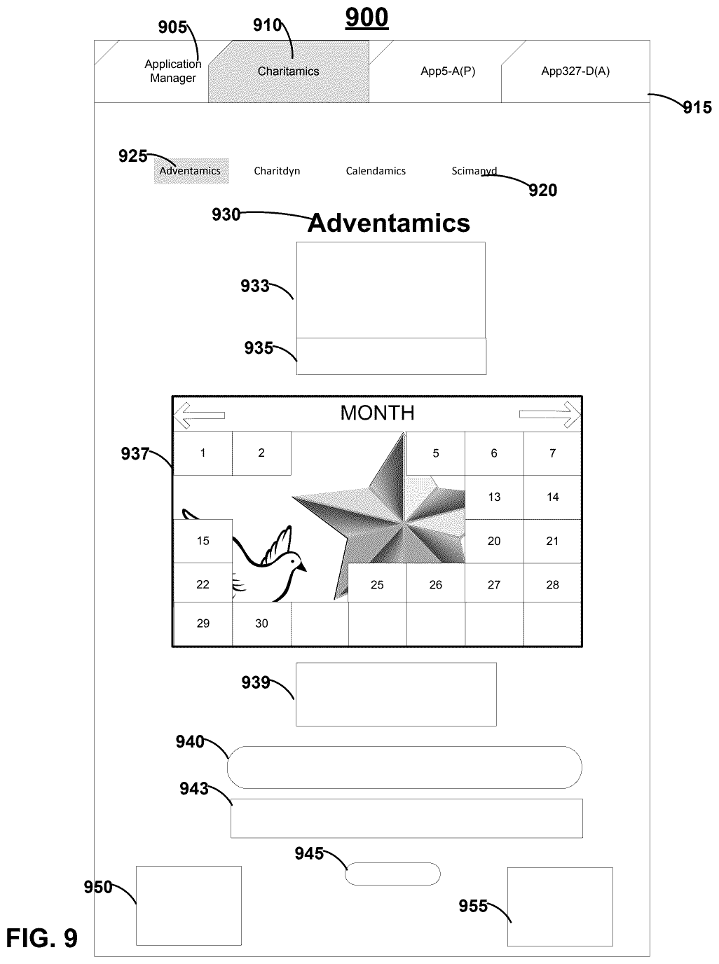

FIG. 9 shows GUI 900 that may include tabs 915, applications 920, application selection display 930, information display 933, contribution summation display 935, advent calendar 937, reward display 939, contribution history display 940, entry field 943, and/or selections 945-955.

Tabs 915 may include one or more tabs used to display one or more application managers (e.g., tab 905) and one or more tabs used to display one or more charitable application provider screens used to, for example, configure third party applications (e.g., tab 910). Applications 920 may be selected to, for example, view different configuration screens for different applications provided by an application provider. For example, application 925 may be selected by a user to display a configuration screen for an application associated with a charitable application provider (e.g., “Charitamics”). Application selection display 930 may visually inform the user that application 925 is currently active. Display 933 may include information related to a charitable application provider, for example, a description of the services provided by a charitable provider via a selected application.

Each of applications 920 may provide one or more features to a user. A feature associated with application 925 may be the opportunity to donate to a charitable cause over a period of time. For example, a user may donate to a charitable cause associated with application 925 for each day of a given month displayed by advent calendar 937. For each day a donation is made the user may receive a reward (e.g., an image, an email including a story related to the particular day, a virtual item, a quote, a digital link, a video and/or the like), and/or a portion of advent calendar may be removed to reveal a hidden message and/or picture. According to at least one example embodiment, removal of days from advent calendar 937 may reveal a lottery number (e.g., a code that may be entered to determine if a prize has been won). Upon removal of all days from the advent calendar, a prize may be awarded to the user. For example, a user may donate a monetary value each day of December and receive an item associated with the New Year (e.g., a coin and/or the like). The item or a graphic representing the item may be displayed in reward display 939.

Donations may be direct (e.g., piggyback charges and/or donation purchases) and/or may be indirect (e.g., meeting performance metrics). Piggyback charges may be a charged amount, rounding up of a purchase amount, charging a percentage equivalent of a purchase and/or the like. Debits from accounts (e.g., using an ACH routing number) and/or any other payment method may be used. According to at least one example embodiment, a user may deposit an amount with an ecosystem provider and the ecosystem provider may provide funds from the deposited amount after, for example, the first purchase of a given day.

According to some example embodiments, purchases credited to the removal of a day from an advent calendar 937 may not occur on the day removed from the calendar. For example, if a purchasing metric is used that requires a purchase for each removal from the advent calendar, and a user is not a prolific purchaser, an early start (e.g., in November) may be provided and/or credit for purchases on one day may be distributed to multiple advent calendar days.

Contribution history display 940 may display, for example, the amount of money (or monetary equivalent) donated by a user from a specified date. Entry field 943 may be used to enter data, for example, an email of a gift recipient, a zip code in which a user wishes a donation to be used and/or the like. Selection 945 may, for example, be selected to update application 925. Selection 950 may be activated to, for example, donate a monetary value for a missed day. Selection 955 may, for example, activate a redemption feature to redeem a completed calendar for a reward identified in reward display 939.

Persons skilled in the art will appreciate that many variations to example embodiments are possible. For example, a charitable application provider may be a religious organization and an advent calendar may be used for each day of lent. A day may be added back and/or an additional amount may be charged if a purchase is made in an establishment selling items inconsistent with a user's observance of lent. An advent calendar application may be used by a pool of users. According to some example embodiments, a user may choose a location in which a donation is used (e.g., via a drop down menu). Selections may be provided to determine a method of donation (e.g., piggybacks, direct donations, and/or the like) and/or an amount of a donation (e.g., 1% of purchase price, $1 per purchase and/or the like). Although example embodiments described with respect to FIGS. 5, 7 and 9 may illustrate independent features, a single page may provide a choice of donation methods (e.g., become a single donator, join a pool of donators and/or donate using an advent calendar). Each method and each configuration may be displayed on, for example, a single GUI display as one scrollable page.

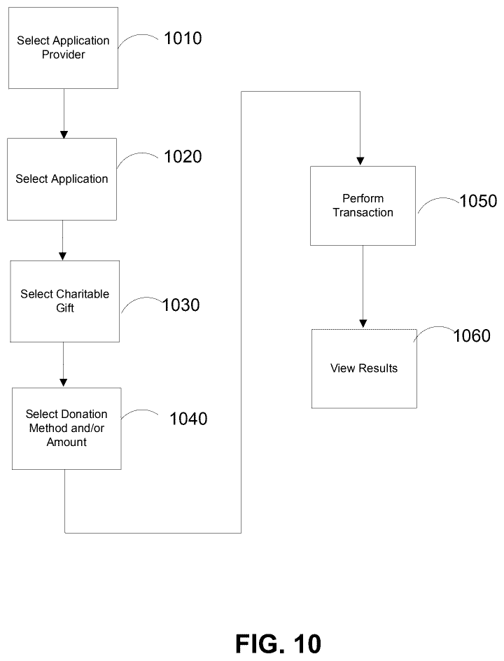

FIG. 10 shows process flow chart 1000. A user may select an application provider and an application provided by the application provider, for example, using GUI 1000 (e.g., as in steps 1010 and 1020). The user may select a charitable gift (e.g., as in step 1030). A method of contributing towards a charitable gift and/or an amount of each contribution may be chosen (e.g., piggyback charges at $1 per use of a card and/or a device card). The user may perform a transaction (e.g., as in step 1050). For example, the user may press a button on, for example, a card associated to the selected application and may purchase an item from a vendor using the card. A result of the purchase may be viewed by a user, for example, by viewing a progress meter displayed on a GUI.

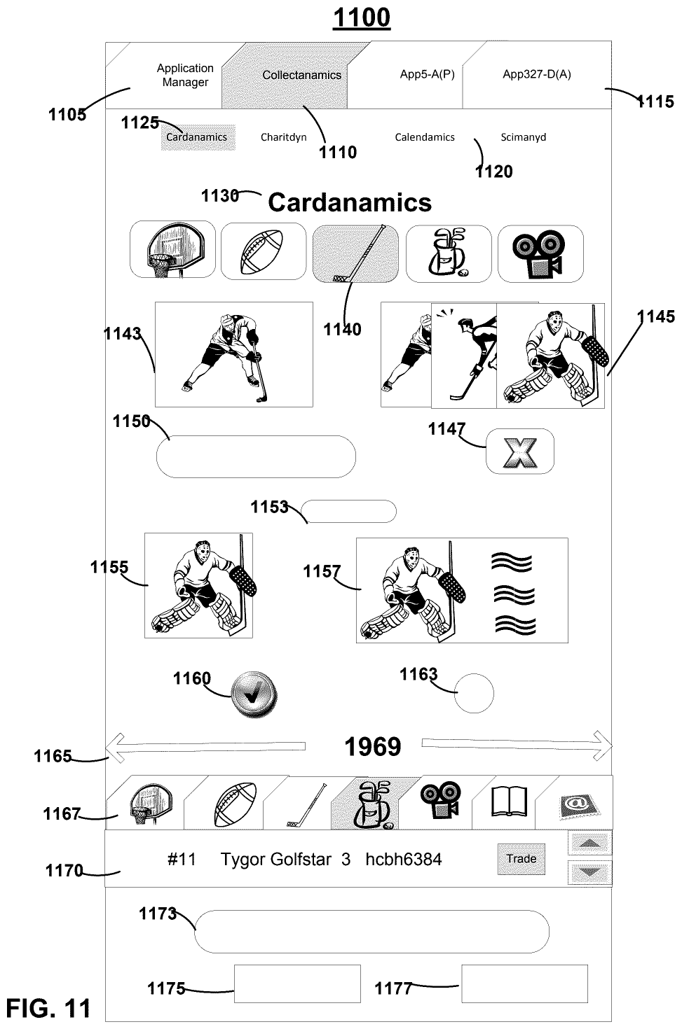

FIG. 11 shows GUI 1100 that may include tabs 1115, applications 1120, application selection display 1130, feature selection 1140, option selection displays 1143 and 1145, option selection 1147, entry field 1150, selection 1153, option selection displays 1155 and 1157, option selections 1160 and 1163, year selection 1165, collection managers 1167, collectable information display and selection 1170, entry field 1173, and/or selections 1175 and 1177.

Tabs 1115 may include one or more tabs used to display one or more application managers (e.g., tab 1105) and one or more tabs (and/or, for example, redirection links to a collectible provider website) used to display one or more collectables application provider screens used to, for example, configure third party applications (e.g., tab 1110). Applications 1120 may be selected to, for example, view different configuration screens for different applications provided by an application provider. For example, application 1125 may be selected by a user to display a configuration screen for an application associated with a collectables application provider (e.g., “Collectanamics”). Application selection display 1130 may visually inform the user that application 1125 is currently active.

Feature selection 1140 may provide a user with one or more choices of features associable to a transactional method. A user may select one or more features using feature selection 1140. A feature may include the opportunity to collect collectables provided by a third party, for example, the opportunity to receive a collectable in exchange for the completion of a performance metric by the user. Collectables may include, for example, virtual and/or physical trading cards, stamps, coins, gaming cards, comics, images of famous persons and/or the like. Performance metrics may be, for example, related to transactions (e.g., a number of purchases using a card and/or a device card, an amount of one or more purchases and/or the like). A collectable application provider may receive a monetary value from, for example, an ecosystem provider, an issuer, a merchant and/or a payment network in exchange for providing collectables to a user. The monetary value may be, for example, a number of basis points (1/100 of a percentage point) related to a transaction.

Option selection displays 1143 and 1145 may display options with respect to a selected feature. For example, a user may receive a reward according to a performance metric by default. The reward may be, for example, a single virtual card as displayed in option selection display 1143. A user may select option selection 1147 to activate an enhancement feature associated with option selection display 1145. For example, an additional charge may be added to each purchase (e.g., a piggyback charge) and a reward may be enhanced. For example, a user may receive a pack of virtual cards (e.g., multiple virtual cards), as displayed in option selection display 1145, in exchange for a monetary value (e.g., via a piggyback charge). According to some example embodiments, two or more piggyback charges may be added to each purchase and collectibles may be transmitted to multiple receivers (e.g., a collectible may be sent to each of multiple email addresses based on multiple piggyback charges).

Entry field 1150 may be, for example, a field used by a user to enter a description, for example, where a user associates a same collectables feature to more than one payment method. Selection 1153 may, for example, be used to update GUI 1100. Option selection displays 1155 and 1157 may display options with respect to a selected feature. For example, a user may use option selection 1160 and 1163 to specify whether the user will receive a front of a card (e.g., preponderantly an image) and/or a front and back of a card (an image and statistics related to the image). Other options may include an image resolution of the collectible, color schemes of the collectible, and/or the like.

Year selection 1165 may change selectable features and/or collection management options. For example, if a collectable genre includes images of Oscar winning performance artists, year selection 1165 may be used to narrow the range of selectable collectables and/or reduce a display of collected collectables. Although year selection 1165 is described with respect to years, other criteria may be used. For example, selection 1165 may be a type selection and user may use selection 1165 to filter by type (e.g., types of stamps).

Collection manager 1167 may list information for each collectable previously awarded to a user and collectables that may be obtained by a user. For example, collection manager 1167 may include selections of types of collectables. Upon selecting a type of collectable, information related to all or a subset of the type of collectable may be available for viewing by a user. The information may be displayed in collectable information display and selection 1170, which may include a selection, a collectable identifier (e.g., name of a golf pro), a number representing a number of the same collectable available to the user (e.g., duplicates), a code associated to the collectable and/or the like. The selection may, for example, initiate a trade of a collectable and/or transfer of a collectable (e.g., as a gift). Entry field 1173 may be used to, for example, enter an email address of the intended recipient of the collectable and/or an address related to any method of transmitting a virtual collectible.

Collectables may belong to a set of collectables (e.g., 250 trading cards). Collectable information display and selection 1170 may, for example, sequentially number collectables in a manner such that each collectable is associated to a particular number. Missing collectables from a set of collectables may be identified (e.g., a collectible entry may be missing or grayed out) and/or a user may determine that a collectable set has been completed. Once a set is complete, selection 1175 may be used to obtain, for example, a reward. A set completion reward may include, for example, a collectable belonging to a master collectable set, a physical item, a different virtual collectible and/or the like. The original set may be removed from the user in exchange for the reward, for example, in exchange for the collectible belonging to the master set (e.g., a master set may be completed by completing multiple non-master sets). Once a master collectable set is complete, selection 1177 may be used to, for example, obtain a reward. As one non-limiting example, a user may be provided a redemption code (e.g., a redemption code redeemable for admittance as a spectator to a professional golf tournament). Master collectables may be sequentially awarded and the completion of a number of collectible sets corresponding to a number of master collectibles may complete a master collectible set. Master collectables may be randomly awarded and the number of required collectible set completions may be unknown prior to completion.

Persons skilled in the art will appreciate that many redemption schemes are possible. According to at least one example embodiment, upon redemption of a collectible set, one or more collectibles may be removed from the user in exchange for a reward. According to at least one example embodiment, upon redemption of a collectible set, half of the collectibles may be removed from the user in exchange for a reward.

According to at least one example embodiments, collectible sets may include short prints. Collectibles may be randomly awarded upon completion of a performance metric and there may be different odds in obtaining different collectibles. One of the collectibles may be especially rare as compared to other collectibles of a set. According to at least one example embodiment, a virtual collectible may be randomly accompanied by a redemption code that is redeemable for an additional reward. Rewards obtainable using the redemption codes may include physical cards (belonging to a collectible physical set and/or a unique card), memorabilia (e.g., a basketball signed by a professional basketball player), a virtual pack of cards, tickets to an event and/or the like. According to at least one example embodiment, a physical collectible set may be conventionally collectible via purchases with the exception of one or more collectibles that may only be obtainable by redeeming redemption codes related to the completion of virtual sets. According to some example embodiments, codes associated with virtual cards may correspond to codes printed on physical cards and may be redeemed for the physical cards. According to some example embodiments, redemption codes are third party redemption codes redeemable for items unrelated to collectables. According to at least one example embodiment, redemption codes may be redeemable for ecosystem currency redeemable from an ecosystem provider.

According to at least one example embodiment, a user may configure GUI 1100 to collect collectables belonging to different sets, genre's and/or the like. For example, GUI 1100 may include one or more blank displays. Vendors may provide ‘drag-and-drop’ collectables icons (e.g., on a vendor website) representing a collectable. A user may drag the vendor icon onto GUI 1100 and GUI 1100 may be automatically modified to include the collectable icon. The icon transfer may include a transfer of billing information (e.g., billing information invisible to a user), a performance metric required to obtain the collectible and/or the like.

An application accessed using GUI 1100 may include configurable functionality to improve a user experience. For example, each collected collectable, or the fact that a user has collected the collectable, may be publically and/or privately displayed. For example, a listing of collectables obtained by the user may be posted on a user's social networking site, on a collector competition website, on a collectable trading website and/or the like. In order to provide configurable functionality, a collectables application provider and/or an application of a collectables application provider may be associated to the user during, for example, an activation process. A user requesting access to a collectables application may be prompted for information. The information may include, for example, security credentials used to access a social networking site associated with the user.

According to example embodiments, a virtual collectable may be transmitted to a user upon completion of a performance metric in various ways. For example, virtual collectibles may be distributed using messaging, email, downloads, webpages and/or any other data transference method.

A performance metric may be based on transactional processing. Transactional processing may include multiple stages. For example, a credit transaction may include authorization, batching, clearing and funding. A collectable provider may provide a virtual collectible to a user at one of the various stages of transaction processing. In some cases, a transaction may be reversed (e.g., a void or credit) after a user receives a reward based on the transaction. For example, a user may purchase an item, receive a virtual collectable and then return the purchased item. According to example embodiments, the collectable provider may be notified by the application manager provider and/or the third party application provider that a transaction has been reversed. A virtual collectable provider may take action based on the notification, for example, a virtual collectable provider may reclaim a reward, invalidate a collectible code associated to the collectible, remove user authorization to use an application and/or the like.

According to some example embodiments, a reward may be granted to a user at a stage of transaction processing (e.g., authorization) but may not be available for use by the user until a different stage of processing (e.g., settlement). If a transaction is reversed (e.g., via a return, a charge-off and/or a charge-back) after being made available to the user the virtual collectible provider may take steps to remove a value associated with the collectable. Accordingly, if a card is used fraudulently (e.g., a stolen card), virtual collectibles may be disassociated with a collectibles system when the purchases are charged-off as a result of the fraudulent spend.

Collectables may be controlled in order to retain intrinsic value, and may be traded and/or sold. For example, an application manager provider may receive virtual collectibles from a collectible provider. A unique code may be embedded in each virtual collectible and managed by the application manager provider. Collectibles may be traded, transferred and or the like, by any method of communication (e.g., phone, email, a web button and/or the like) using the embedded code. The code may be visible to a user or may be invisible to a user (e.g., an embedded barcode). The application manager provider may track the current owner of the collectible. According to at least one example embodiment, both the sender and the receiver of a collectible must authorize a collectible transfer when a collectible is already part of a collection (e.g., using an application manager). For example, a transferor may be required to transmit a code to a transferee and enter an email address of a transferor (e.g., using an application manager).

Persons skilled in the art will also appreciate that the present invention is not limited to only the embodiments described. Instead, the present invention more generally involves dynamic information. Persons skilled in the art will also appreciate that the apparatus of the present invention may be implemented in other ways than those described herein. All such modifications are within the scope of the present invention, which is limited only by the claims that follow.

What is claimed is:

1. A system comprising:
a first collectible owned by a first user account, said first collectible having a first unique identification number not visible by said first user account, wherein said first collectible is a virtual trading card;
a second collectible owned by said first user account, said second collectible having a second unique identification number not visible by said first user account, wherein said second collectible is a physical trading card;
a third collectible operable to be owned by a second user account, wherein said second collectible and third collectible are operable to begin to be traded between said first user account and said second user account upon receiving a trade initiation request from one of said first user account and said second user account.

2. The system of claim 1, wherein said first collectible is a virtual representation of said second collectible and said first collectible and said second collectible are digitally coupled together within said system.

3. The system of claim 2, wherein said second collectible and said third collectible are stored in a remote location on behalf of said first and second user accounts respectively.

4. The system of claim 2, wherein said second user is provided with said first collectible as a result of being traded with said first user and ownership of said second collectible.

5. The system of claim 1, wherein said second collectible was provided to said first user account as a result of said first user account completing a set of tasks.

6. The system of claim 5, wherein said set of tasks comprises collecting a complete set of collectibles.

7. The system of claim 6, wherein said complete set of collectibles is removed from said first user account in exchange for said second collectible.

8. The system of claim 1, wherein said second collectible was obtained by said first user account as a result of achieving a first performance metric.

9. The system of claim 1, where said second collectible was obtained by said first user account as a result of initiating a specific purchase transaction.

10. The system of claim 1, where said second collectible was obtained by said first user account after settlement of a specific purchase transaction.

11. The system of claim 1, where said second collectible was obtained by said first user account as a result of initiating a specific purchase transaction and before settlement of said specific purchase transaction.

12. The system of claim 1, wherein said first collectible and second collectible are managed by a collection manager and operable to be displayed on a graphical user interface, wherein said first collectible is operable to be displayed with: a first collectible identifier, a number representing how many of said first collectible said user first account owns, and a first image of said first collectible, and said second collectible is operable to be displayed with: a second collectible identifier, a number representing how many of said second collectible said user first account owns, and a first image of said second collectible.

13. A system comprising:
a first collectible owned by a first user account, said first collectible having a first unique identification number not visible by said first user account, wherein said first collectible is a virtual trading card;
a second collectible owned by said first user account, said second collectible having a second unique identification number not visible by said first user account, wherein said second collectible is a physical trading card;
a third collectible operable to be owned by a second user account, wherein said second collectible and third collectible are operable to be traded between said first user account and said second user account upon receiving a first user trade authorization from said first user account and a second user trade authorization from said second user account; and
a fourth collectible owned by said first user account, said fourth collectible being sellable and tradeable to other user accounts in said system.

14. The system of claim 13, wherein said fourth collectible is part of a first set of collectibles, said first user account being awarded a fifth collectible upon completing said first set of collectibles.

15. The system of claim 13, wherein said first, second, and third collectibles are viewable to all user accounts on said system.

16. The system of claim 13,
wherein said first user account is operable to purchase a pack of collectibles on said system, said pack of collectibles are a pack of trading cards; and
wherein pack of trading cards comprises a pack of physical trading cards and a pack of images of said physical trading cards which are operable to be viewed on said system.

17. The system of claim 13, wherein said first user account is operable to be awarded a pack of collectibles on a daily basis.

18. The system of claim 17, wherein said first user account is operable to view each individual collectible in said daily pack of collectibles, and wherein each viewed collectible is moved to said first user account's collection of collectibles upon initial viewing of each individual collectible.

19. The system of claim 13, wherein said fourth collectible was obtained by said first user account as a result of achieving a first performance metric.

20. A system comprising:
a first collectible, wherein said first collectible is a digital collectible;
a second collectible, wherein said second collectible is a physical collectible; and
a collection manager for viewing a collectible collection, wherein said first collectible and second collectible are purchased in a digital transaction, said first collectible and second collectible are placed in said collectible collection, and a selectable option is operable to change the viewable collectible collection based on selection criteria.
